(19) United States
(12) Patent Application Publication
(10) Pub. No.: US 2013/0108023 A1
(43) Pub. Date: May 2, 2013

(54) Development of a double crystal monochromator

(71) Applicant: Alex Deyhim, Ithaca, NY (US)

(72) Inventor: Alex Deyhim, Ithaca, NY (US)

(21) Appl. No.: 13/373,023

(22) Filed: Nov. 2, 2011

(51) Int. Cl. G21K 1/06

(52) U.S. Cl. 378/85

(57) ABSTRACT

A high-precision water-cooled, small offset, double crystal monochromator has been developed for use with beamline. The design incorporates the supports and gravity feed water cooling of two diamond or silicon crystals correctly positioned about a common rotation axis so that the incident and diffracted beam do not walk off the edges of the crystals within the energy range 6-15 KeV (30°<q<11.6°). In the 34ID implementation, the first crystal sees unfocussed pink beam from an undulator. The second crystal has a ±5° motorized tilt motion around an axis parallel to its face and around the beam direction.

### STATEMENT REGARDING FEDERALLY SPONSORED RESEARCH OR DEVELOPMENT

This work was supported in part by the National Science Foundation under: Contract No. DMR-9724294 and DOE DEFG02-91ER45439

### CROSS REFERENCE TO RELATED APPLICATIONS

Not applicable

### SEQUENCE LISTING OR PROGRAM

Not applicable

### BACKGROUND OF THE INVENTION

The high power associated with the x-ray beams generated by the third generation synchrotron radiation facilities has created new challenges in the design of the beamline components that intercept the x-ray beams. The challenge is especially critical in the design of the monochromators, which must provide acceptable performance under the thermal load of the x-ray beams. Research activities in the development of monochromators for more stable and less complicated beamlines have led to examination of many aspects of the monochromators' design.

Described herein is the design and features of a new monochromator that has only one moving part inside the chamber, and a preliminary study of the design is provided as well as characterization aspects of a diamond crystal.

### SUMMARY OF THE INVENTION

The overall philosophy of the design is to keep to a minimum the number of essential motions of the crystals. This minimizes the opportunities for instabilities, vibrations and drift. Crystal translation axes are therefore avoided altogether by using a small offset of just 2 mm between the parallel crystal faces. The resulting beam offset is below 4 mm (for symmetric reflections) and this varies by a fraction of a millimeter over the entire energy range, typically 6 to 15 keV. This variation is not normally noticeable in an experiment.

The only motion necessary to be placed in-vacuum is a single crystal tilt. Because of the small offset, it is unnecessary to use independent tilts (“chi”) on both crystals. The primary drive motions for both crystals are passed through the vacuum wall via differentially pumped seals. The novel use of coaxial drives means that it is the differential theta motion that is controlled (“delta-theta”).

Energy is scanned by a single motor so the crystal pair moves as a channel cut. This leads to very stable tracking of the energy over wide ranges as we describe in this paper. The use of a delta-theta configuration with a narrow range also means it can be heavily geared down for fine adjustment. This also avoids the problem of crashing the crystals when the offset is so small.

### BRIEF DESCRIPTION OF DRAWINGS

The invention as described herein with references to subsequent drawings, contains similar reference characters intended to designate like elements throughout the depictions and several views of the depictions. It is understood that in some cases, various aspects and views of the invention may be exaggerated or blown up (enlarged) in order to facilitate a common understanding of the invention and its associated parts.

FIG. 1 shows a parametric solid model

FIG. 2 shows the main structural component of the monochromator, the Huber 420 rotator, mounted vertically.

FIG. 3 shows Ion Chamber Intensity vs. Monochromator Energy.

### DETAILED DESCRIPTION OF INVENTION

Provided herein is a detailed description of one embodiment of the invention. Therefore, specific details enclosed herein are not to be interpreted as limiting, but rather as a basis for the claims and as a representative basis for teaching one skilled in the art to employ the present invention in virtually any appropriately detailed system, structure, or manner.

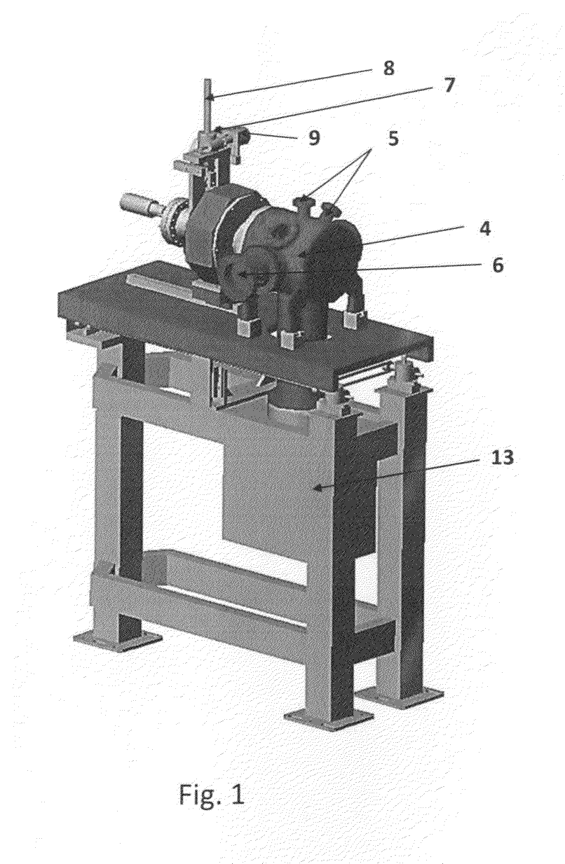

The design was created using parametric solid models as shown in FIG. 1. Finite Element Analysis was conducted on several critical parts to determine the possible deflection under different load and heat constraints

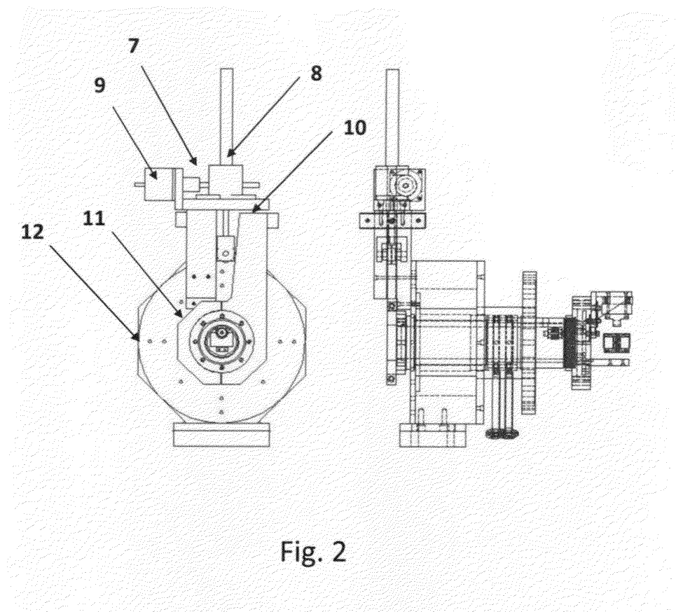

The main structural component of the monochromator is the Huber 420 rotator, mounted vertically as shown in FIG. 2. To the non-rotating part of this is mounted a main body 4 assembly which contains the differential pumping ports 5, a flange 6 to mate with the tank, and bearings and seals for the common crystal rotator spool which passes through it. This common crystal rotator passes through the main rotator and is attached to its rotating part. Also mounted here is the first crystal rotator 7.

When its motor 9 is run, a screw jack 8 is operated which moves a roller assembly up and down. This roller assembly bears against the angled side of the long free arm 10, which, with the short free arm 11, forms a clamp around the first crystal spool. The first crystal spool rotates on bearings inside the common rotator 12. When the rollers run down, the first crystal rotates and the angle of reflection decreases. When the rollers run up, springs which link the fixed screw jack 8 and motor mounting bracket to the long free arm 11, cause opposite rotation, thus the incident angle increases.

The components of the monochromator includes a first crystal holder, a second crystal holder, a Compton shield, a feedthrough flange 6, tank, fixed horizontal entrance aperture, Motorized 20 mm vertical height adjustment of the entire monochromator/tank/pump assembly (stand) 13, and Gravity Feed Cooling System.

The first crystal holder is a copper block excavated under the crystal and cooled by a continuous water tube starting and ending outside the vacuum. This tube features sections with wave-like bends to accommodate rotation of the crystal holder relative to the tubing entrance/exit flange.

The second crystal holder tilts ±5° by being attached to a small vacuum-compatible tilt stage driven by an arrangement of miniature gears, shafts and couplings connected to a motorized feedthrough. A short manual horizontal adjustment is also incorporated. Both holders incorporate a matrix of very small tapped holes for attachment of the crystals.

The Compton shield is attached to the second crystal holder to absorb parasitic radiation emitted from the first crystal. It is cooled by a tube virtually identical to that on the first crystal holder. Because of the very small area through which these tubes must pass, and their proximity to each other, the four wave-like areas mentioned above are staggered so they can nest together without interference.

The feedthrough flange 6 incorporates numerous ports for electrical connections and the second crystal tilt motor, and holes for passage of the four water cooling tubing ends. The tank surrounds the crystal holders and has vacuum flanges for connecting to the monochromator body, the pump; beam in and out, viewport and utility. Its mounting feet incorporate T-slots with set screws for small manual position adjustment.

The fixed horizontal entrance aperture protects the crystal holders from mis-steered beam. It is made from Glidcop explosion-bonded to stainless steel and contains water-cooling channels and fittings.

The motorized 20 mm vertical height adjustment of the entire monochromator/tank/pump assembly is a welded three-legged stand 13 made from four-inch square tubing. On top of this are three screw jacks driven by a single stepper motor via a driveshaft and gearbox. These jacks support an aluminum plate with a large round cutout for pump attachment. To this plate are attached the tank and a length of rail on which the body of the monochromator slides for easy removal from the tank.

The gravity feed cooling system is put in place in order to reduce vibrations of the crystals induced by the cooling water flow by constructing a low pressure closed loop system. Water is stored in a 40 1 stainless steel tank approximately 1.5 m above the monochromator and is gravity fed through separate lines for each of the two crystals. The water is collected in a large polypropylene tank beneath the monochromator and a sump pump periodically returns the water to the steel storage tank.

The completed monochromator was tested in hutch 34-ID-B, providing a monochromatic beam that was monitored with an ion chamber in hutch 34-ID-C. Synthetic Diamond (111) crystals (Sumitomo) of approximate dimension 9×5×0.5 mm were attached to the copper mounting blocks. Two #2-56 screws held tantalum straps across each end of the crystals. A strip of indium was used between the copper and the crystal to provide an extended area for thermal contact.

It was found by x-ray topography that the crystals were easily strained so the clamping screws were loosened afterwards until they were just finger-tight. The final positions of the crystals were set with a lateral offset of 7.5 mm (along the beam) and a vertical offset of 2.5 mm. This allowed tuning of the energy over the required 6-15 keV range while keeping the beam reasonably centered and with only a fraction of a millimeter change in vertical displacement.

The rocking curve was measured by scanning the delta-theta motion that changes the angle of the second crystal relative to the first. The rocking curve width corresponded to about 0.1 mm of motion of the screw-jack wedge-drive, or about 200 steps on the motor. This was found to be sufficiently geared-down for routine tuning and very little backlash were observed, once the standard motor-backlash correction was employed.

The tilt motion (chi) provided smooth horizontal beam steering with relatively little coupling to the delta-theta motion. The chi motion could be scanned, but a small residual backlash effect was obtained, perhaps arising from the gear chain; even though this could probably be corrected, it was not found to be inconvenient.

The great advantage of the simple design is the resulting stability. No feedback system was required to keep the monochromator tuned up. Some downward drift of the intensity was detected, which required re-optimization of delta-theta approximately every 12 to 24 hours. From a “cold” start, the relative motion moved by almost one rocking-curve-width in the first hour, but not significantly afterwards. Because of the relatively good stability, we did not benefit enormously from operation in “top-up” mode, as other groups have found.

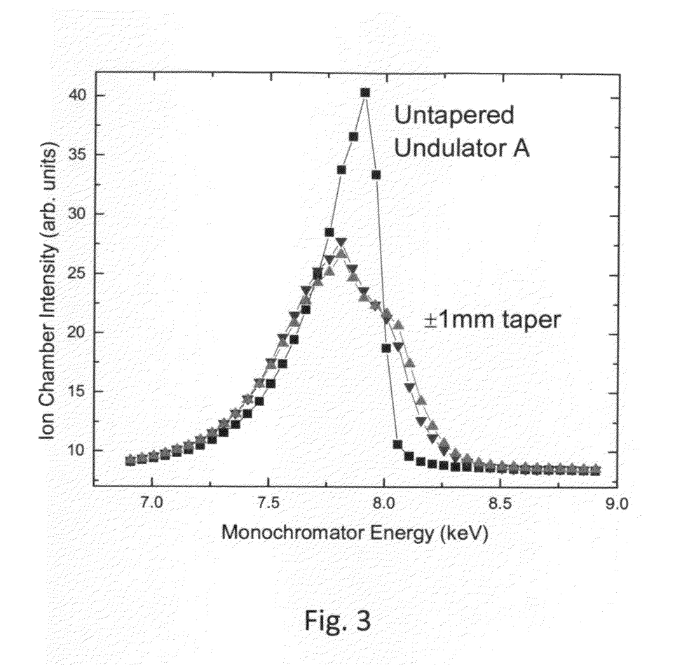

Wide-ranging energy scans could be performed routinely, as shown in FIG. 3. The spectrum of undulator “A” at sector 34 was measured with an ion chamber, for three different settings of the “taper.” This measurement is used to verify that the taper is calibrated correctly in our installation. The calibrated undulator “gap” was set to 8.0 keV, but the peak in the spectrum was found to be at 7.9 keV because of the angular integration over the horizontal emission cone of the undulator.

For this measurement, 1 mm vertical and 0.25 mm horizontal slits were used in front of the beam-splitting mirror [1], which is located 26 m from the source. The mirror is a liquid-nitrogen-cooled block of Si coated with Pt [1]. The monochromator was located at 46 m.

What is claimed is:

1. A double crystal monochromator comprised of:
(a) A first crystal holder;
(b) A second crystal holder;
(c) A Compton shield;
(d) A feedthrough flange;
(e) A tank;
(f) A fixed horizontal entrance aperture;
(g) A motorized vertical height adjustment assembly;
(h) Gravity feed cooling system.

2. The apparatus of claim 1 wherein said first crystal holder is a copper block burrowed under the crystal and cooled by a continuous water tube starting and ending outside the vacuum, featuring sections with wave-like bends to accommodate rotation of the crystal holder relative to the tubing entrance/exit flange.

3. The apparatus of claim 1 wherein said second crystal holder tilts ±5° by being attached to a small vacuum-compatible tilt stage driven by an arrangement of miniature gears, shafts and couplings connected to a motorized feedthrough.

4. The apparatus of claim 1 wherein both the first and second crystal holder include a matrix of very small tapped holes for attachment of the crystals.

5. The apparatus of claim I wherein said Compton shield is attached to the second crystal holder to absorb parasitic radiation emitted from the first crystal, and is cooled by a tube virtually identical to that on the first crystal holder.

6. The apparatus of claim 1 wherein said feedthrough incorporates numerous ports for electrical connections and the second crystal tilt motor, as well as holes for passage of the four water cooling tubing ends.

7. The apparatus of claim 1 wherein said tank surrounds the crystal holders and has vacuum flanges for connecting to the monochromator body, the pump, beam in and out, viewport and utility.

8. The apparatus of claim 1 wherein said fixed horizontal entrance aperture protects the crystal holders from mis-steered beam, and is made from Glidcop explosion-bonded to stainless steel and contains water-cooling channels and fittings.

9. The apparatus of claim 1 wherein said motorized vertical height adjustment assembly serves as a movement platform for the monochromator, tank and pump, and is a welded three-legged stand made from four-inch square tubing and three screw jacks driven by a single stepper motor via a driveshaft and gearbox.

10. The apparatus of claim 9 wherein said jacks support an aluminum plate attached to the tank and length of rail on which the body of the monochromator slides for easy removal from the tank, also with a round cutout for pump attachment.

11. The apparatus of claim 1 wherein said gravity feed cooling system is put in place in order to reduce vibrations of the crystals induced by the cooling water flow by constructing a low pressure closed loop system.

12. The apparatus of claim 11 wherein water used for said cooling system is stored in a 40 1 stainless steel tank approximately 1.5 m above the monochromator and is gravity fed through separate lines for each of the two crystals; water is collected in a large polypropylene tank beneath the monochromator and a sump pump periodically returns the water to the steel storage tank.

13. The main structural component of claimed monochromator of claim 1 wherein said component is the Huber 420 rotator and is mounted vertically, comprised of
(i) A screw jack;
(j) First crystal rotator;
(k) A motor;
(l) A long free arm;
(m) A short free arm;
(n) A crystal common rotator.

14. The non-rotating portion of claimed monochromator of claim 1 wherein said portion is mounted to the main body assembly and contains differential pumping ports, a flange to mate with the tank of claim 7, and bearing and seals for crystal rotator spool with passes through.

15. The apparatus of claim 13 wherein said screw jack is operated by said motor and moves a roller assembly up and down.

16. The apparatus of claim 13 wherein said long free arm is pressed against the roller assembly of claim 15, which, with said short free arm of claim 13, forms a clamp around the first crystal spool.

17. The apparatus of claim 13 wherein said common crystal rotator contains the first crystal spool which rotates on bearings inside of said common crystal rotator.

18. The apparatus of claim 13 wherein said first crystal rotates when rollers run down and the angle of reflection decreases.

19. The apparatus of claim 13 wherein when rollers run up, springs linking said fixed screw jacks and motor mounting brackets to said long free arm, cause opposite rotation, this increasing the incident angle.
